(19) United States
(12) Patent Application Publication
(10) Pub. No.: US 2014/0372334 A1
(43) Pub. Date: Dec. 18, 2014

(54) SYSTEM AND METHOD FOR ANONYMOUS MAILING OR SHIPPING SERVICES

(71) Applicant: Anonymous Shipping, LLC, Manchester, NH (US)

(72) Inventor: Craig D. Wrentmore, Wayland, MA (US)

(21) Appl. No.: 14/299,780

(22) Filed: Jun. 9, 2014

Related U.S. Application Data
(60) Provisional application No. 61/834,791, filed on Jun. 13, 2013.

(51) Int. Cl. G06Q 10/08

(52) U.S. Cl. CPC G06Q 10/083
USPC 705/330

(57) ABSTRACT

A method and apparatus for sending a an item via mailing or shipping process to a destination mailing address without the sender of the item obtaining any identifiable information about the recipient of the item. The process also allows the user with the ability to provide unidentifiable information to third party mailing or courier/shipping services. The system and method safeguards personal information about recipients of items. The process involves leveraging a waypoint processing facility and the assignment of unique codes for the final destination locations. The waypoint processing facility is responsible for receiving items mailed or shipped from the original sender, looking up the unique anonymous code provided by the anonymous address to obtain the appropriate final destination address assigned to the code, and sending the item to the final destination address.

### RELATED APPLICATION

This application claims priority to, and the benefit of, co-pending United States Provisional Application No. 61/834,791, filed Jun. 13, 2013, for all subject matter common to both applications. The disclosure of said provisional application is hereby incorporated by reference in its entirety.

### FIELD OF THE INVENTION

The present invention relates to a process for anonymous mailing or shipping services suitable for a user attempting to protect their personal information (i.e., remain anonymous to an original sender) throughout the mailing or shipping process. In particular, the present invention relates to safeguarding a mailing or shipping destination address and other personally identifiable information generally found in the sending or receiving of mail or shipments.

### BACKGROUND

Generally, when items are mailed or shipped using online systems, users of the services must provide an address in order to have items mailed or shipped directly to them (e.g., a home address when the user wishes to have items mailed or shipped to their home). The online websites often keep such addresses on file along with additional personal information about the user, such as credit card information and other personal details. Many websites also track the IP address of users and can use this information as they see fit for their own use. For instance, the final mailing or shipping address can be associated with the IP address of the user initiating the shipment. Companies that specialize in tracking web usage, or even hackers who infiltrate an unsuspecting website, can gain knowledge relating to who requested a shipment, where the shipment was sent, the frequency with which the user visits websites, which web pages are viewed by that user, and the like.

Even when online services are not utilized, anyone sending an individual mail or a shipment knows the name and address of that individual. That information can be used to send targeted marketing materials or to keep a running list of items shipped to that individual.

### SUMMARY

There is a need for protecting personal information during the mailing or shipping process while also making the process more secure. The present invention is directed toward further solutions to address this need, in addition to having other desirable characteristics. Specifically, the anonymous mailing or shipping process of the present invention enables a user at any point in time to create a mailing or shipping address that does not contain any personal identification information that is decipherable by a sender. The address can then be provided unrestricted to anyone or anything, online, over the phone, or in any context, while completely protecting personal identification information of the individual or user having the destination mailing address. All details about the user and their destination mailing address remain unknown.

In accordance with one embodiment of the present invention, a method of handling a mailed or shipped item includes receiving an item mailed or shipped to an anonymous address, the anonymous address comprising a waypoint address and a unique anonymous code. The anonymous address is transformed into a user destination address. The item is sent to the user destination address. The item is sent to the user destination address without an original sender of the item being informed, aware of or otherwise having access to, the user destination address.

In accordance with aspects of the present invention, the waypoint address does not convey personal user identification information. The unique anonymous code does not convey personal user identification information that is decipherable by the original sender. The anonymous address does not convey personal user identification information to the original sender that is decipherable by the original sender. The method may further include re-labeling the item with the user destination address prior to sending the item to the user destination address. The step of transforming the anonymous address into a user destination address can include a database storing the anonymous address in association with the user destination address receiving an inquiry, the inquiry containing the anonymous address, and the database generating an indication of the user destination address.

In accordance with further aspects of the present invention, the user destination address can include a mailing or shipping address that identifies a physical location. The method can further include identifying the item at the waypoint address as either junk mail or not junk mail. The method can further include providing the user with the ability to indicate handling of items identified as junk mail to either send them to the user destination address, or to an alternate location. The alternate location can be a recycling process.

In accordance with one embodiment of the present invention, a method of creating an anonymous mailing or shipping address, includes receiving a user destination address. A unique anonymous code is identified. The user destination address is associated with the unique anonymous code, and storing the unique anonymous code in association with the user destination address in a memory storage device. The user destination address is transformed into an anonymous address by generating a mailing or shipping address comprising a waypoint address in combination with the anonymous code. The waypoint address does not convey any user identification information.

### BRIEF DESCRIPTION OF THE FIGURES

These and other characteristics of the present invention will be more fully understood by reference to the following detailed description in conjunction with the attached drawings, in which:

FIG. 1 is a flowchart depicting the steps for associating an anonymous code with a user destination address;

FIG. 2 is an illustrative user destination address;

FIG. 3 is an illustrative anonymous code;

FIG, 4 is an illustrative anonymous address combining a waypoint address with the anonymous code;

FIG. 5 is a diagrammatic illustration of a computing device capable of storing associated anonymous codes and user destination addresses;

FIG. 6 is a flowchart depicting a method of labeling an item with an anonymous address provided to a sender and the user receiving the mail item at the user destination address, in accordance with the present invention; and

FIG. 7 is a flowchart depicting a method of handling junk mail items.

### DETAILED DESCRIPTION

An illustrative embodiment of the present invention relates to a system and method of handling a mailed item that maintains user anonymity. The system and method provide for sending of a mailed item to an anonymous address. The anonymous address is transformed into a user destination address. The mailed item is then sent to the user destination address, without revealing the user destination address to the original sender of the mailed item.

It should be noted that although many use the terms shipping and mailing interchangeably, they are not the same. Mailing refers to use of the international postal system, which is run jointly by international governments. Shipping refers to private-sector couriers. In both instances, mailing and shipping, a destination address is required. The present invention is operable for both mailing and shipping processes, and the destination address (or user destination address) referred to herein is intended to indicate both mailing and/or shipping addresses.

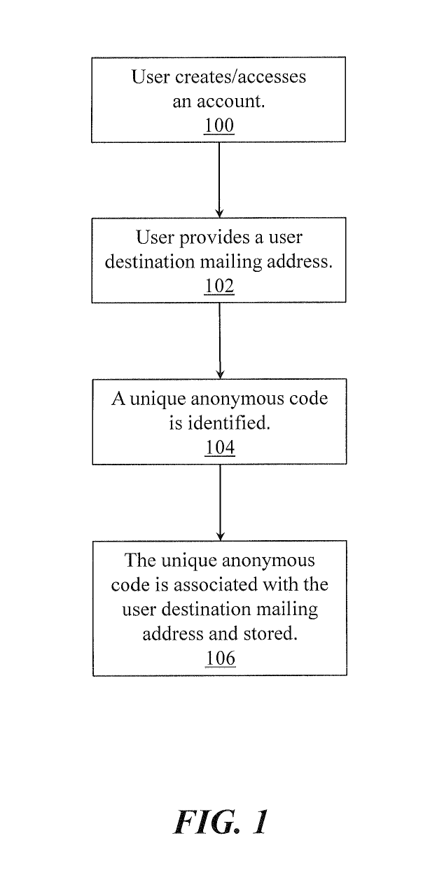

FIGS. 1 through 7, wherein like parts are designated by like reference numerals throughout, illustrate an example embodiment of the anonymous mailing or shipping system and method according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

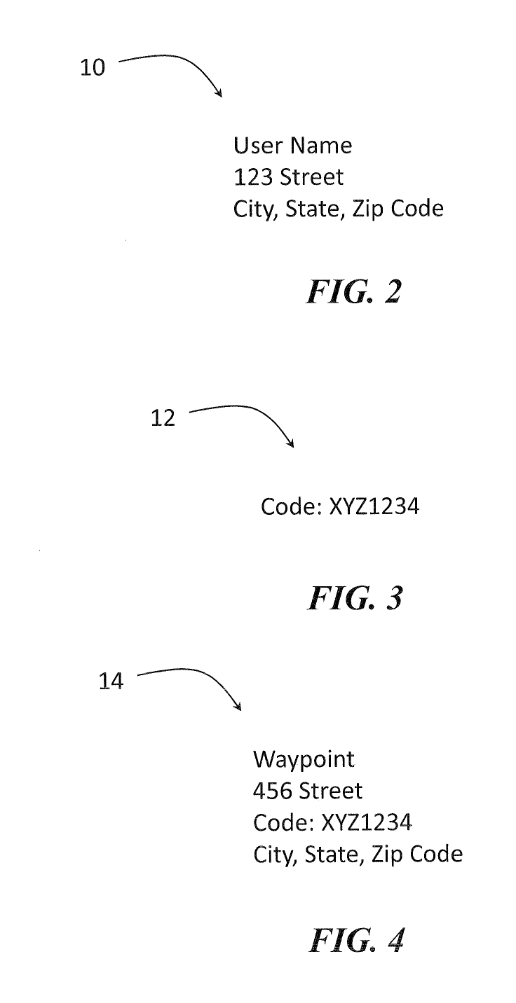

Turning to FIGS. 1 and 2, a user wishing to maintain anonymity with third parties that need to send mail items to the user creates or accesses a previously created account (step 100). The user provides a user destination address 10 (step 102). The user destination address can be, for example, the user's home address or their work address, or some other address where the user is generally located. The user destination address conventionally includes items like user name, company name, geographical location information by street, city, state, and zip code, and the like. Such information either separately, or in combination, can convey various personal identification information about the user. A user destination address 10 is generally not considered to be an anonymous piece of information. For example, user names are clearly useful in identifying an individual user. Correlation of the user name with a house number, street, town, etc., reveals personal identification information that the user may not wish to reveal. In some instances, security questions related to password protection relate to house number information or city/town information in which the user lives, and such information can be leveraged by, e.g., hackers, to gain access to otherwise secured user information, accounts, or the like.

A unique anonymous code 12 is identified (step 104). The unique anonymous code 12 can be formatted in numerous different ways, an illustrative example of which is shown in FIG. 3. For example, the unique anonymous code 12 can be all alpha characters, all numeric characters, or a combination thereof. The unique anonymous code 12 can make use of other characters and symbols if desired. The unique anonymous code 12 can be of any number of characters, but those of skill in the art will appreciate that the unique anonymous code 12 is preferably of a conventional length for fitting on a mailing address label. As such, the present invention can be utilized in conjunction with numerous different formats of unique anonymous code 12, such that the present invention is not limited by the illustrative examples provided herein.

The unique anonymous code 12 is associated with the user destination address 10, and stored. For example, the present invention can make use of a computer or other similar hardware device (as described herein as a computing device 500) having access to a database in a memory 512 where the unique anonymous code 12 and the user destination address 10 can be stored in association with each other. If a query is performed on the unique anonymous code 12, the associated user destination address 10 can be determined. If a query is performed on the user destination address 10, the associated unique anonymous code 12 can be determined.

The user can choose to provide more than one user destination address within the same user account. However, each user destination address receives a different unique anonymous code.

The unique anonymous code 12 can be combined with a waypoint address to form an anonymous address 14 as depicted in FIG. 4. The waypoint address can be any interim location, but in accordance with an illustrative example of the present invention the waypoint address is the mailing address of a processing facility. The processing facility is equipped to receive incoming mail or shipments sent to the anonymous address 14, access the computer with access to the database storing the unique anonymous code 12 in association with the user destination address 10, and identify the user destination address 10 as described later herein. The processing facility is further equipped to re-label the mailed or shipped item and send it to the user destination address 10.

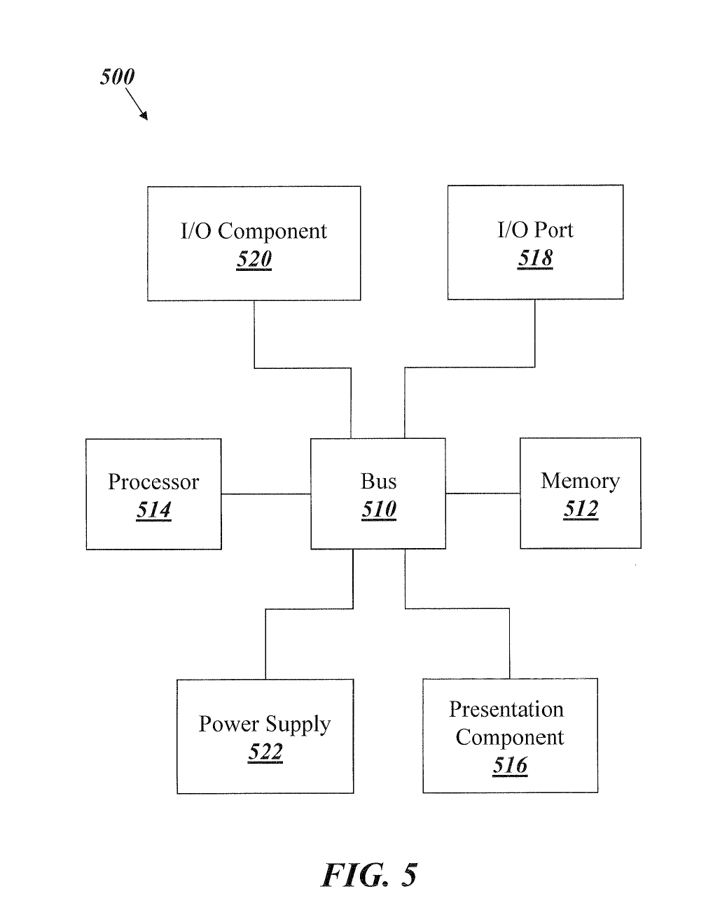

FIG. 5 illustrates an example of a computing device 500 for implementing aspects of the illustrative methods and systems of the present invention. The computing device 500 is merely an illustrative example of a suitable computing environment and in no way limits the scope of the present invention, A “computing device,” as represented by FIG. 5, can include a “workstation,” a “server,” a “laptop,” a “desktop,” a “hand-held device,” a “mobile device,” a “tablet computer,” or other computing devices, as would be understood by those of skill in the art. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 522. One of skill in the art will appreciate that the bus 510 can include one or more busses, such as an address bus, a data bus, or any combination thereof. One of skill in the art additionally will appreciate that, depending on the intended applications and uses of a particular embodiment, multiple components can be implemented by a single device. Similarly, in some instances, a single component can be implemented by multiple devices. As such, FIG. 5 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 512 can include computer-storage media in the form of volatile and/or nonvolatile memory. The memory 512 can be removable, non-removable, or any combination thereof. A database can be stored within the memory 512. Exemplary hardware devices are devices such as hard drives, solid-state memory, optical-disc drives, and the like.

The computing device 500 can include one or more processors 514 that read data from components such as the memory 512, the various I/O components 520, etc. Presentation component(s) 516 present data indications to a user or other device. Exemplary presentation components 516 include a display device, speaker, printing component, vibrating component, etc.

The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, blue-tooth device, networking device, and the like.

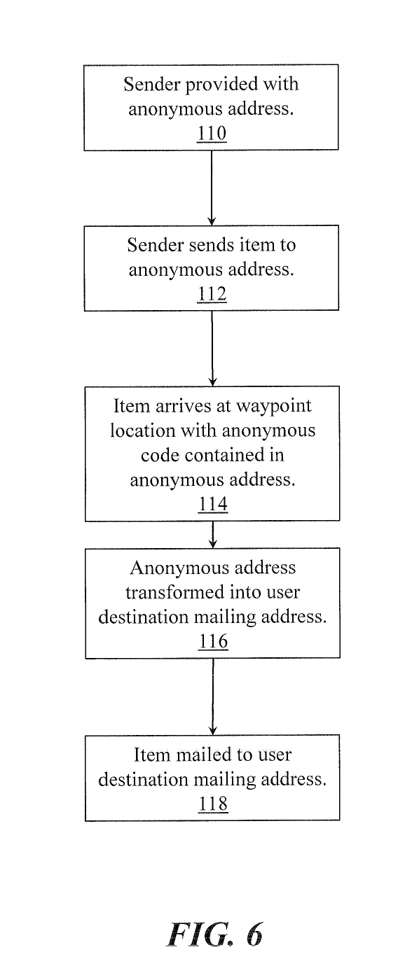

Returning now to the system and method of the present invention, FIG. 6 illustrates the process of the user providing the anonymous address 14 to a sender, and eventually receiving the mailed or shipped item, without the sender ever obtaining the user destination address. Specifically, the sender is provided with the anonymous address 14 (step 110). The sender sends the item to the anonymous address 14 (step 112). The item arrives at a waypoint location with the unique anonymous code 12 contained in the anonymous address 14 (step 114). The anonymous address 14 is transformed into the user destination address 10 (step 116) by accessing the database stored in, e.g., the computing system 500, containing the anonymous address 14 associated with the user destination address 10. Because this lookup is performed when the mailed or shipped item arrives at the waypoint or subsequent thereto, the original sender has no access whatsoever to such information, thus preserving the anonymity of the user destination address, and likewise the anonymity of the user. The item can be re-labeled, or otherwise the mailing address can be updated, and the item is sent to the user destination address 10 (step 118).

In operation, the anonymous mailing system and method of the present invention involves an independent processing facility at the waypoint that operates between the original shipping or mailing location (i.e., the original sender) and the final shipping or mailing location (i.e., the user destination address). The processing facility is responsible for receiving items from the original sender and then forwarding those items to the final destination. A user of the process obtains unique codes that are added to the address portion of shipments and the processing facility uses those codes to forward the items. The user may provide the processing facility address and code to others so their personal information remains confidential even when a third party sends out an item on their behalf. The user's details remain completely anonymous to the sender.

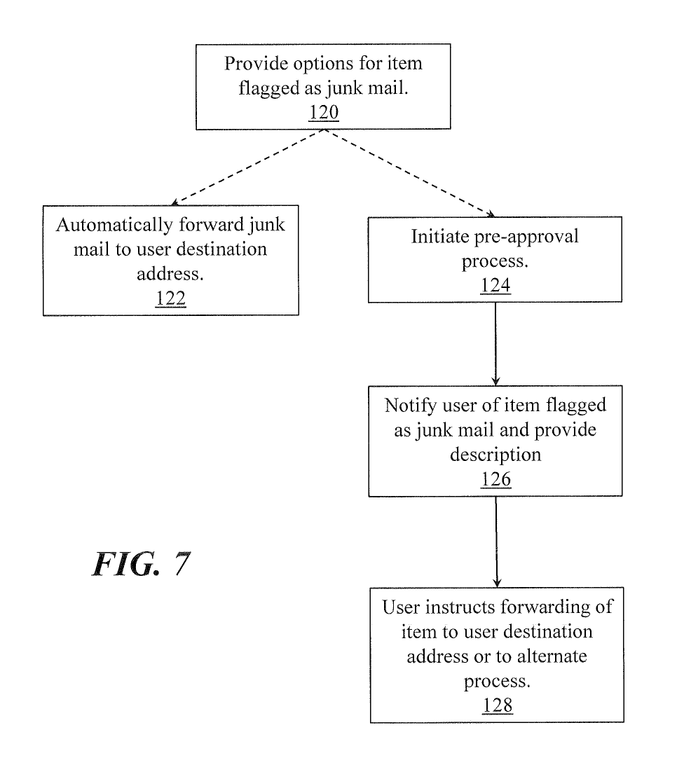

Referring to FIG. 7, the system and method of the present invention can also address junk mail. Users are provided options for any mail or shipment received by the waypoint that is flagged as junk mail (step 120). The user can have the junk mail automatically forwarded the same as any other mail or shipment as described herein (step 122). Alternatively, the user can elect to have a pre-approval process initiated at the waypoint (step 124). The waypoint notifies the user when an item is received and is flagged as junk mail, and provide a basic description of the item, the sender, and the like (step 126). The user then instructs the system (e.g., by login to their account) (step 128) to either have the junk mail item either forwarded to the user destination address, or to an alternate process such as being recycled at the waypoint.

In making use of the system and method of the present invention as described herein, a user's personal details remain completely anonymous to the sender of an item. The user will provide the address of the processing facility and the unique code to others. They have no way to determine the final destination of the shipment or mailing because the only information they have available is in the form of a generic anonymous code. The anonymous code has no meaning without the original reference to the final address, which only the processing facility has access to obtain.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall there between.

What is claimed is:

1. A method of handling a mailed or shipped item, comprising:
receiving an item mailed or shipped to an anonymous address, the anonymous address comprising a waypoint address and a unique anonymous code;
transforming the anonymous address into a user destination address; and
sending the item to the user destination address;
wherein the item is sent to the user destination address without an original sender of the item being informed, aware of, or otherwise having access to, the user destination address; and
wherein the waypoint address and the user destination address are different.

2. The method of claim 1, wherein the waypoint address does not convey personal user identification information.

3. The method of claim 1, wherein the unique anonymous code does not convey personal user identification information that is decipherable by the original sender.

4. The method of claim 1, wherein the anonymous address does not convey personal user identification information to the original sender that is decipherable by the original sender.

5. The method of claim 1, further comprising re-labeling the item with the user destination address prior to sending the item to the user destination address.

6. The method of claim 1, wherein the step of transforming the anonymous address into the user destination address comprises a database receiving an inquiry, the database storing the anonymous address in association with the user destination address, the inquiry containing the anonymous address, wherein the database provides the user destination address, thus transforming the anonymous address into the user destination address.

7. The method of claim 1, wherein the user destination address comprises a mailing or shipping address that identifies a physical location.

8. The method of claim 1, further comprising identifying the item at the waypoint address as either junk mail or not junk mail.

9. The method of claim 8, further comprising providing the user with an ability to indicate handling of items identified as junk mail to either send them to the user destination address, or to an alternate location.

10. The method of claim 9, wherein the alternate location comprises a recycling process.

11. A method of creating an anonymous address, comprising:
receiving a user destination address;
identifying a unique anonymous code;
associating the user destination address with the unique anonymous code, and storing the unique anonymous code in association with the user destination address in a memory storage device; and
transforming the user destination address into the anonymous address by generating a mailing or shipping address comprising a waypoint address in combination with the unique anonymous code;
wherein the waypoint address does not convey any user identification information; and
wherein the waypoint address is different from the user destination address.

12. The method of claim 11, wherein the waypoint address does not convey personal user identification information.

13. The method of claim 11, wherein the unique anonymous code does not convey personal user identification information that is decipherable by an original sender.

14. The method of claim 11, wherein the anonymous address does not convey personal user identification information to an original sender that is decipherable by the original sender.

15. The method of claim 11, wherein the step of transforming the anonymous address into a user destination address comprises a database receiving an inquiry, the database storing the anonymous address in association with the user destination address, the inquiry containing the anonymous address, wherein the database provides the user destination address, thus transforming the anonymous address into the user destination address.

16. The method of claim 11, wherein the user destination address comprises a mailing or shipping address that identifies a physical location.
